(19) United States
(12) Patent Application Publication
(10) Pub. No.: US 2004/0128925 A1
(43) Pub. Date: Jul. 8, 2004

(54) Continuous head and sill assembly and combined spacing member and side panel support therefore

(75) Inventor: Victor T. Massey, Winston-Salem, NC (US)

Correspondence Address: PILLSBURY WINTHROP, LLP, P.O. BOX 10500, MCLEAN, VA, 22102, US

(73) Assignee: The Stanley Works, New Britain, CT

(21) Appl. No.: 10/673,645

(22) Filed: Sep. 30, 2003

Related U.S. Application Data
(60) Provisional application No. 60/414,651, filed on Oct. 1, 2002.
(60) Provisional application No. 60/414,655, filed on Oct. 1, 2002.

(51) Int. Cl. E06B 1/04

(52) U.S. Cl. 52/204.1

(57) ABSTRACT

A spacing member and side panel support for a door jamb assembly are disclosed. The combined spacing member and side panel support includes a body structure with a pair of opposing surfaces. One of the surfaces includes a mullion-supporting surface to support a mullion thereon. The one surface further includes a side panel support surface to support one side panel. The side panel support surface is laterally spaced from the mullion-supporting surface such that a side panel located on the side panel support surface abuts the mullion located on the mullion-supporting surface. The other of the opposing surfaces has a contoured sill-engaging surface to generally conform to a topographic configuration of the sill. The body structure is configured such that, when the sill-engaging surface is engaged with the sill, the mullion-supporting surface and the side panel support surface are oriented generally horizontally. The mullion-supporting surface has a generally complimentary shape to the mullion.

### CROSS REFERENCE TO RELATED APPLICATIONS

This application relates to and claims priority to U.S. Provisional Patent Application No. 60/414,651, which was filed on Oct. 1, 2002 and U.S. Provisional Patent Application No. 60/414,655, which was filed on Oct. 1, 2002.

### BACKGROUND OF THE INVENTION

1. Field of the Invention

The present invention relates to a modular mounting assembly for doors and, more particularly, to a continuous header and sill assembly having an innovative spacing member and side panel support member that simplify the manufacture of the mullion assembly while reducing exposure to rot. The present invention is also directed to a continuous header and sill assembly having an innovative combined side panel support and spacing member. The spacing and support members may be used on either a high profile or low profile sill assembly.

2. Description of Related Art

Typically, sills for doorways are constructed of wood and shaped to a proper configuration or formed of metal, such as by an extrusion process. Sills generally are shaped to facilitate passage through the doorway, such as being sloped toward an exterior of the doorway. Sills are usually formed with a longitudinally extending channel to allow a seal member to be positioned therein to contact a downwardly facing bottom surface of a door when the door is in a closed position and act as a thermal break.

Additionally, doorways are often constructed with at least one side panel adjacent the door. The side panels may be windows or opaque panels. When a side panel is provided, a mullion is positioned vertically between the door and the side panel to support and serve as an attachment means for the side panel and to provide a jamb for one side of the door (either the hinge or latching side of the door). It is noted that there may also be an additional side panel opposite the first side panel on the other side of the door. In this case, there are usually two mullions provided. In order for the mullion to positively engage the sill, a bottom of the mullion is formed to have a complimentary shape. For example, a tenon is formed to fit within the channel and a portion is formed at an incline, in order for the mullion to be in complete contact with the sill. This machining process is generally rather difficult to perform, since the cuts made within the mullion are done so on its end and transverse to the longitudinal direction of the mullion. This also adds to the expense of creating the mullion.

Similarly, it has been proven difficult to attach a bottom portion of the side panel to the sill, since the configuration of the sill is typically incompatible with the side light or panel. To allow securing of the side panel to the sill, it is often necessary to machine custom adapters to fit between the sill and side panel to allow connection therebetween. This process has also proven to be a difficult one.

### OBJECTS OF THE INVENTION

It is an object of the present invention to provide a continuous head and sill assembly having a spacing member that overcomes the above-described deficiencies in the prior art.

It is an object of the present invention to provide a spacing member that allows a mullion to be coupled to a sill without superfluous machining of the mullion.

It is another object of the present invention to provide a continuous head and sill assembly having a spacing member that automatically locates the mullion in the proper orientation on the sill assembly during assembly.

It is another object of the present invention to provide a spacing member that permits easy mounting of the mullion to the sill assembly.

It is another object of the present invention to provide a spacing member that is easy to install and position relative to the sill.

It is another object of the present invention to provide a spacing member that can quickly and easily be used to secure the mullion to the sill assembly.

It is another object of the present invention to provide a spacing member that is resistant to decay.

It is another object of the present invention to provide a spacing member that may be used either on the left hand side or the right hand side of a door panel.

It is another object of the present invention to provide a spacing member configured to permit the drainage of water therefrom, thereby reducing the rot potential of the mullion and other door components.

It is another object of the present invention to provide a spacing member may be used in either a high profile sill assembly or a low profile sill assembly.

It is another object of the present invention to provide a spacing member that may be retrofitted into door jamb assemblies as a replacement part.

It is another object of the present invention to provide a side panel support for a side panel of door.

It is yet another object of the present invention to provide a side panel support that locates the side panel in proper orientation during installation.

It is another object of the present invention to provide a side panel support that is capable of being used with the spacing member for the mullion assembly.

It is another object of the present invention to provide a side panel support that may be used in either a high profile sill assembly or a low profile sill assembly.

It is another object of the present invention to provide a combined side panel support and spacing member for using a continuous head and sill assembly, whereby the side panel support and the spacing member are integrated into a single component.

It is another object of the present invention to provide a combined side panel support and spacing member that may be used in either a high profile sill assembly or a low profile sill assembly.

### SUMMARY OF THE INVENTION

In response to the foregoing challenges, applicant has developed an innovative spacing member for a continuous head and sill assembly that simplifies the manufacturing of the mullion assembly and reduces exposure to rot.

In accordance with the present invention, a spacing member for a door jamb assembly is provided, wherein the door jamb assembly includes a horizontally extending sill structure disposed between and connected to ends of a pair of vertically extending jamb members. A horizontally extending header structure is disposed between and connected to opposite ends of the jamb members. A vertically extending mullion is disposed between the jamb members. The spacing member includes a body structure with a pair of opposing surfaces, one of the surfaces having a mullion-supporting surface to support the mullion thereon, the other of the opposing surfaces having a contoured sill-engaging surface to generally conform to a topographic configuration of the sill. The body structure is configured such that, when the sill-engaging surface is engaged with the sill, the mullion-supporting surface is oriented generally horizontally. In use, the spacing member is located on the sill assembly in the desired orientation. The mullion is then located thereon. At least one suitable fastener is extending from the sill assembly through the spacing member into the lower end of the mullion.

The present invention is also directed to a combined spacing member and side panel support for a doorjamb assembly. The jamb assembly includes a horizontally extending sill structure disposed between and connected to ends of a pair of vertically extending jamb members. A horizontally extending header structure is disposed between and connected to opposite ends of the jamb members. At least one vertically extending mullion is disposed between the jamb members and at least one side panel is disposed between the mullions and the jambs. The combined spacing member and side panel support includes a body structure with a pair of opposing surfaces. One of the surfaces includes a mullion-supporting surface to support a mullion thereon. The one surface further includes a side panel support surface to support one side panel. The side panel support surface serves to properly orient the side panel during installation. The side panel support surface is laterally spaced from the mullion-supporting surface such that a side panel located on the side panel support surface abuts the mullion located on the mullion-supporting surface. The other of the opposing surfaces or lower surface has a contoured sill-engaging surface to generally conform to a topographic configuration of the sill. The body structure is configured such that, when the sill-engaging surface is engaged with the sill, the mullion-supporting surface and the side panel support surface are oriented generally horizontally. The mullion-supporting surface has a generally complimentary shape to the mullion.

In accordance with the present invention, the body structure includes a horizontally extending portion configured to extend horizontally outwardly past the mullion. At least one lateral locating structure extends vertically from the horizontally extending portion past the mullion-supporting surface. The lateral locating structures are configured to contact the at least one mullion to prevent lateral movement thereof. An upwardly extending flange extends substantially along a length of the side panel support surface. The upwardly extending flange is adapted to engage a side panel supported on the side panel support surface. Caulking or a suitable sealant may be located between the flange and the side panel support to provide a waterproof seal between the components. In accordance with the present invention, the at least one lateral locating structure extends from the upwardly extending flange.

### BRIEF DESCRIPTION OF THE DRAWINGS

The invention will be described in conjunction with the following drawings in which like reference numerals designate like elements and wherein:

FIG. 1 is a front plan view of a continuous header and sill assembly embodying principles of the present invention;

FIG. 2 is an exploded perspective view of the continuous header and sill assembly shown in FIG. 1;

FIG. 3 is a cross-sectional view of a sill and mullion shown in FIG. 2 taken along line 3-3 in FIG. 1;

FIG. 4 is a cross-sectional view of the mullion and spacing member shown in FIG. 1 taken along line 4-4 located on a high profile sill assembly;

FIG. 5 is a right front perspective view of one embodiment of a spacing member shown in FIG. 4;

FIG. 6 a cross-sectional view of the mullion and spacing member shown in FIG. 4 taken along line 6-6 in FIG. 1;

FIG. 7 is a right front perspective view of another embodiment of spacing member shown in FIG. 4;

FIG. 8 is another perspective view of the spacing member shown in FIG. 5;

FIG. 9 is a cross-sectional view of the spacing member shown in FIG. 5 and the mullion located on a high profile sill assembly;

FIG. 10 is a cross-sectional view of a high profile sill assembly, side panel support, and side panel taken along line 10-10 in FIG. 1;

FIG. 11 is a cross-sectional view of the sill and a rail member taken along line 11-11 in FIG. 1;

FIG. 12 is a side view of the spacing member located on a low profile sill assembly in accordance with the present invention;

FIG. 13 is a side view of the side panel support located on a low profile sill assembly in accordance with the present invention;

FIG. 14 is a left front perspective view of a right side combined spacing member and side panel support in accordance with another embodiment of the present invention;

FIG. 15 is a bottom perspective view of a right side combined spacing member and side panel support of FIG. 14;

FIG. 16 is a top view of a right side combined spacing member and side panel support of FIG. 14; and

FIG. 17 is a front perspective view of a left side combined spacing member and side panel support in assembled position with a side panel and a mullion.

### DETAILED DESCRIPTION OF PREFERRED EMBODIMENTS

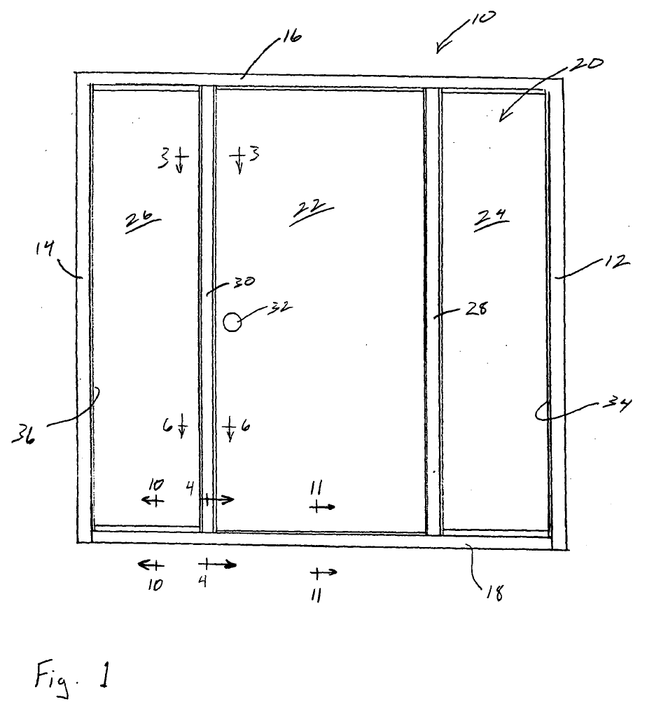

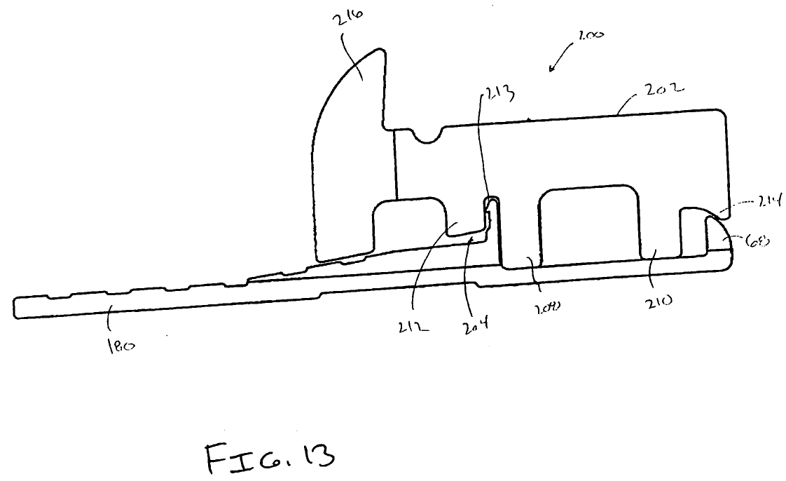

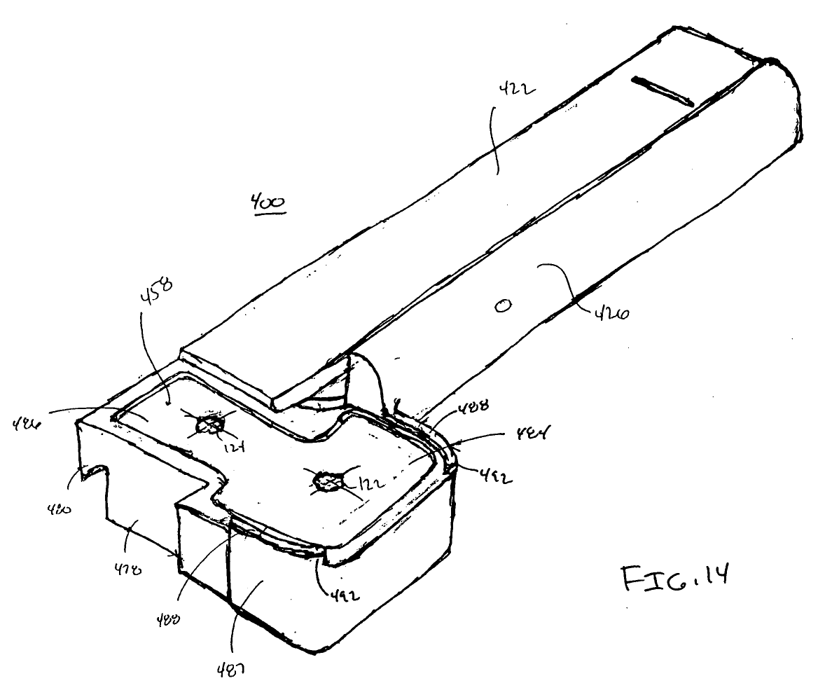

FIG. 1 shows a continuous head and sill assembly 10 incorporating the present invention. The continuous head and sill assembly 10 includes a pair of vertically extending horizontally spaced jamb members 12, 14, a horizontally extending header structure 16 attached at opposite ends thereof to upper ends of the jamb members 12, 14, and a horizontally extending sill structure 18 connected to lower ends of the jamb members 12, 14 and extending therebetween. The pair of jamb members 12, 14, the header structure 16, and the sill structure 18 form a generally rectangular door jamb opening, indicated at 20, within which a door 22 is disposed. The sill structure 18 illustrated is a high profile sill assembly. The present invention, however, is not intended to be limited for use solely with high profile sill assemblies; rather, it is contemplated that the present invention may be used in connection with a low profile sill assembly 180, as illustrated in FIGS. 12 and 13.

The continuous head and sill doorjamb assembly 10 is representative of a typically used doorjamb assembly and includes the door 22 and side panels 24, 26 disposed on opposing sides of the door 22. The present invention is not limited to use with the specific configuration of head and sill assembly 10 shown and other various configurations are contemplated, for example, assembly may include a pair of doors, at least one sliding door panel, a combination of fixed and movable door panels and any combination of side panels including only one side panel disposed on one side of the door. The head and sill assembly may be equipped with a high profile sill or a low profile sill.

To accommodate the placement and support of the side panels 24, 26, the head and sill assembly 10 includes a pair of vertically extending mullions 28, 30, which are connected at upper ends thereof to the header structure 16 and at lower ends thereof to the sill structure 18. The mullions 28 and 30, as well as, the jamb members 12 and 14 and the header structure 16 may be formed from various materials. It is contemplated that these members may be formed from wood, a wood-polymer composite, an extruded polymer, plastic or any combination of these materials. For example, a coextrusion of a wood flour composite with an outer exterior polymer layer. As shown, the mullion 28 is disposed between the door 22 and side panel 24, while the mullion 30 is disposed between the door 22 and side panel 26. In the illustrated embodiment of the doorjamb assembly 10, the door 22 is shown to include a latching mechanism, such as a door knob 32 on a left-hand side of the door 22 and has hinge structures (not shown) operatively connected between a right-hand side of the door 22 and the mullion 28. For this embodiment, the mullion 30 is configured to latchingly engage with the latching mechanism 32. The embodiment illustrated provides for two side panels 24 and 26. It is contemplated that one of the side panels may be eliminated such that the corresponding mullion is also removed.

The mullion 28, jamb member 12, header structure 16, and sill structure 18 define a side panel opening 34 therebetween within which the side panel 24 is disposed and the mullion 30, jamb member 14, header structure 16, and sill structure 18 define a side panel opening 36 therebetween within which the side panel 26 is disposed.

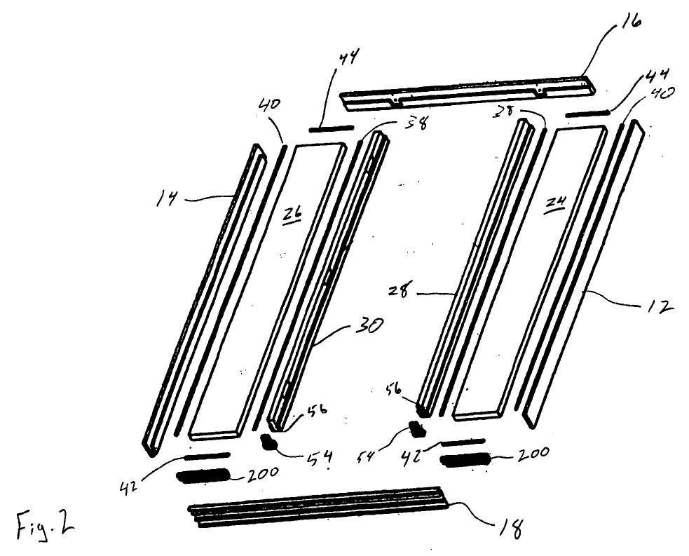

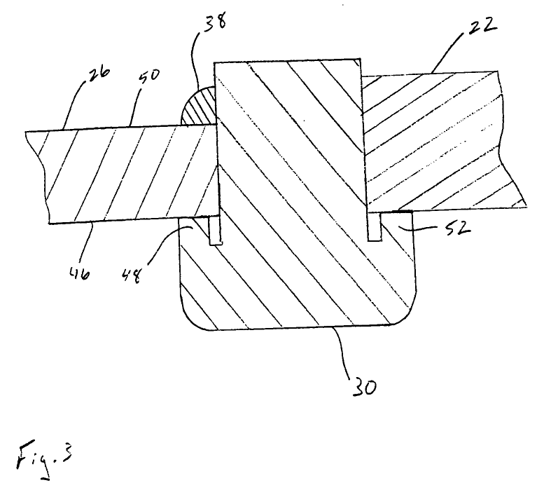

As shown in FIG. 2, each of the side panels 24, 26 is retained within the respective side panel opening 34, 36 by pairs of vertically extending glazing beads 38, 40 and horizontally extending glazing beads 42, 44. In particular, glazing beads 38 are placed in abutting relation to respective side panels 24, 26 and secured to corresponding mullions 28, 30. Glazing beads 40 are placed in abutting relation to respective side panels 24, 26 and secured to corresponding jamb members 12, 14. Glazing beads 42 are positioned in abutting relation to respective side panels 24, 26 and may be secured to either the sill structure 18 or side panel spacers 200, as will be discussed in further detail below. Glazing beads 44 are positioned in abutting relation to respective side panels 24, 26 and are secured to the header structure 16. As shown in further detail in FIG. 3, for example, the side panel 26 is secure to the mullion 30 with the glazing bead 38. In particular, a first face 46 of the side panel 26 abuts a first laterally extending portion 48 of the mullion 30, while a second face 50 abuts the glazing bead 38, thereby retaining the side panel 26 between the glazing bead 38 and first portion 48. As further shown, the door 22 abuts the weather strip installed in a second laterally extending portion 52 of the mullion 30.

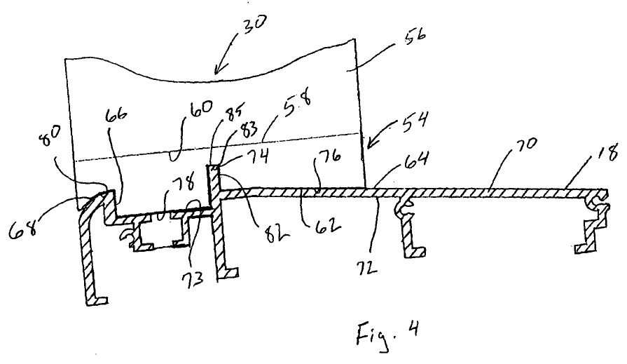

Referring back to FIG. 2, a spacing member 54 is disposed between lower ends 56 of mullions 28, 30 and the high profile sill structure 18. A spacing member 54 located on a low profile sill structure 180 is shown in FIG. 12. Shown in greater detail in FIG. 4, the spacing member 54 includes a generally horizontally extending mullion supporting surface 58 that engages a downwardly facing surface 60 of the mullion. With such an arrangement, no spacing machinery of the lower end of the mullion is necessary. Additionally, the spacing member 54 includes a sill engaging surface 62 that is contoured to a topographic configuration of the sill structure 18. As shown, the sill engaging surface 62 may be configured to compliment an upwardly facing surface 64 of the sill structure 18. A sealing assembly (not shown) may be positioned between the surface 62 and the upwardly facing surface 64. The sealing assembly may include caulk or other suitable sealant applied to at least one of the sill engaging surface 62 and the surface 64. This arrangement provides at least two advantages in that 1) the complex machining of the lower portion 56 of the mullions is eliminated, rather, the lower portion 56 may need only be cross cut which is a relatively simple process and 2) the vertically directed force from the mullion may be securely transferred to the sill structure 18 due to the abutment of the sill engaging surface 62 with the upwardly facing surface 64 of the sill structure 18.

It is noted that the upwardly facing surface 64 of the sill structure 18 may be formed with any shape, construction, or configuration and that the sill engaging surface 62 of the spacing member 54 may be configured to compliment any of these. However, in order to provide an adequate description herein, the sill structure 18 is shown with an exemplary shape, construction, and configuration. In particular, the sill structure 18 is shown as a generally longitudinally extending extrusion, which may be formed, for example, by an extrusion process utilizing a metal material. The sill structure 18 is shown to include a longitudinally extending U-shaped channel 66 and a generally arcuate trailing edge portion 68. Additionally, the sill structure 18 may include a leading edge portion 70 providing a generally inclined ramp portion 72. Furthermore, the sill structure 18 is formed with a longitudinally extending upwardly protruding lip structure 74 adjacent the channel 66 and between the channel 66 and the ramp portion 72.

To compliment the upwardly facing surface 64 of the sill structure 18, the sill engaging surface 62 of the spacing member 54 may be formed with a first portion 76 that is inclined to be generally parallel with the inclined portion 72 of the sill structure 18. The sill engaging surface 62 may also include a generally depending second portion 78 generally parallel with the mullion supporting surface 58 to be received within the channel 66 to engage a bottom surface 73 of the channel 66. A third portion 80 may be provided by the sill engaging surface 62 and may be inclined and generally arcuate to cooperate with the arcuate trailing edge portion 68. Furthermore, the spacing member 54 may be formed with a laterally extending channel 82 to receive the lip structure 74. Although as shown, the channel 82 is sized to abut the lip structure 74, the channel 82 may have increased dimensions as shown in FIG. 12, to accommodate a seal. As shown, the channel 66 provides a downwardly facing surface 83 to engage an upper surface 85 of the lip structure 74. With this configuration, the spacing member 54 securely and substantially continuously abuts the surface 64 of the sill structure 18. It is also noted that the spacing member 54 is substantially prevented from lateral movement relative to the sill structure 18 when position thereon, due to an interlocking cooperation between, for example, the lip structure 74 and channel 84 and the channel 66 and the second portion 78. However, the spacing member 54 may be allowed movement longitudinally along the sill structure 18, since the features of the sill structure 18 may extend along the sill structure 18 in the longitudinal direction thereof. A suitable gap may be provided between these components to permit the inclusion of one or more sealing assemblies. The present invention, however, is not limited to the above-described configuration of the surface 62; rather, numerous configurations are contemplated so long as the contour of the surface 62 is complementary to the upper surface 64.

With the arrangement illustrated in FIG. 4, the spacing member 54 eliminates the need to form a tenon on the end of the mullion and allows the mullion to be square cut. Additionally, positioning of the mullion relative to the sill structure 18 is made simpler, since the spacing member 54 is prevented from lateral movement relative to the sill structure and, thus only the longitudinal placement of the spacing member relative to the sill structure need be determined.

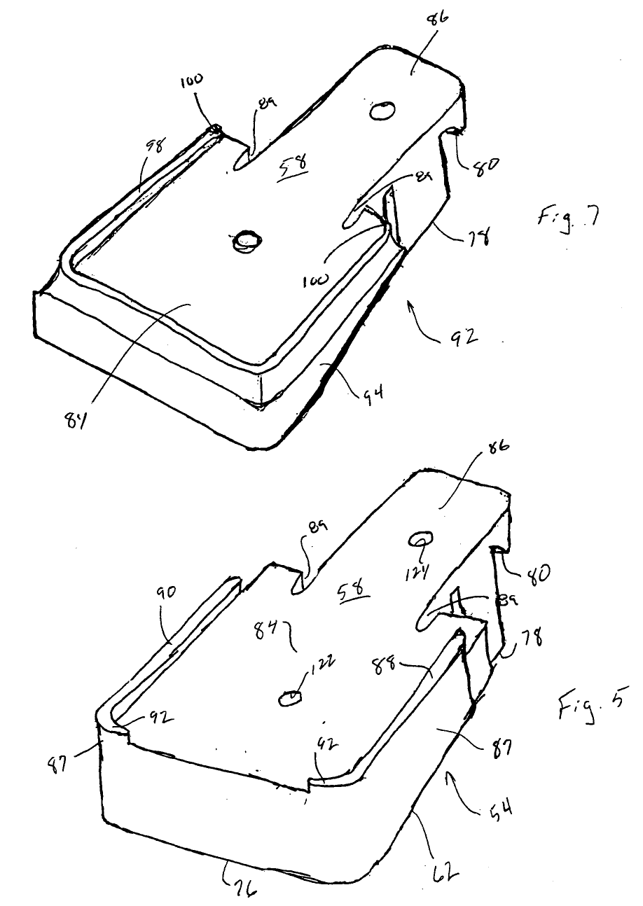

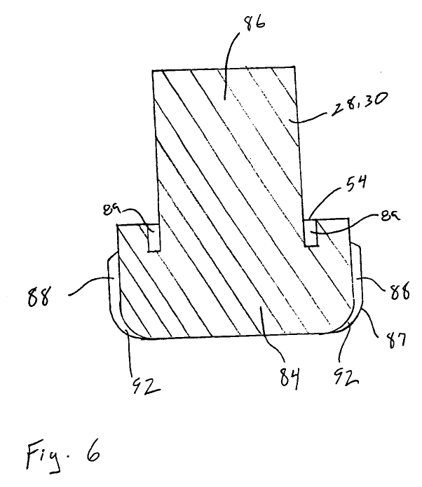

One embodiment of the spacing member 54 is shown in FIGS. 5 and 6. As shown, the mullion engaging surface 58 is shaped to generally coextend with the downwardly facing surface 60 of the mullions. A general shape of the spacing member 54 also generally compliments the sectional shape of the mullions, which may be generally T-shaped. Accordingly, the spacing member 54 includes a laterally extending portion 84, which extends outwardly corresponding to the first and second laterally extending portions 48, 52 of the mullions 28, 30 (shown in FIG. 6) and a longitudinally extending portion 86. Additionally, the spacing member 54 may be provided with a horizontally extending portion 87 that extends outwardly from at least one side of the spacing member 54 past a horizontal extent of the mullion. A lateral locating structure 88 may be provided extending upwardly from the horizontally extending portion 87 to abut a peripheral surface of the mullion, thereby providing lateral support thereof in at least one direction. The spacing member shown in FIG. 5 is configured such that the horizontally extending portion 87 extends outwardly from lateral edges of the laterally extending portion 84 and a pair of locating structures 88, 90 extend upwardly from respective horizontally extending portions. The locating structure 90 has a similar construction to the locating structure 88. As also shown, the lateral locating structures 88, 90 include arcuate portions 92 that serve to extend partially around a leading edge face of the mullion.

As shown further in FIG. 6, the horizontally extending portion 87 may extend from each lateral edge of the laterally extending portion 84. In this manner, the lateral locating structures 88 and 90 may engage corresponding lateral faces of the mullions 28, 30. The arcuate portions 92 may curve around the lateral faces of the mullions 28, 30 to, at least, partially engage a forward face of the mullions 28, 30. Accordingly, the mullions 28, 30 may be substantially horizontally retained relative to the spacing member 54 in at least three directions. Additionally, the spacing member 54 having the lateral locating structures 88, 90 is self-draining, in that water may flow (i.e., drain) off the forward end of the spacing member through a space between the locating structures 88, 90. Accordingly, water is substantially prevented from collecting between the spacing member 54 and the corresponding mullion 28, 30, which may promote decay of the mullion or spacing member itself (if constructed of, for example, wood). The spacing member 54 may include a pair of notches or grooves 89 formed in the surface 58. The grooves 89 are sized to receive weather striping located on one or both side of the mullion 30.

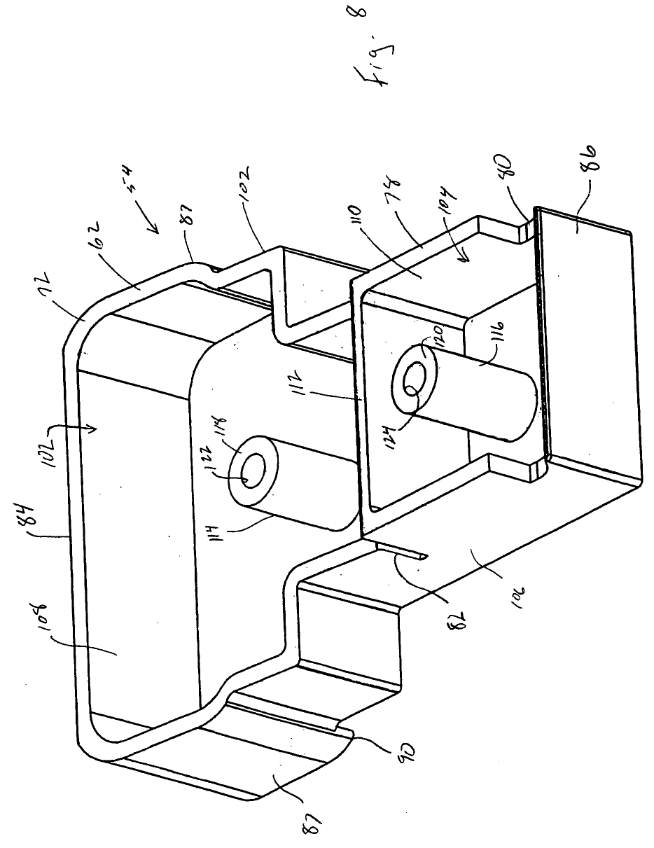

FIG. 7 shows another embodiment of a spacing member, indicated at 92. Features of the spacing member 92 substantially identical with those of spacing member 54 are indicated by identical reference numbers. A horizontally extending portion 94 extends outwardly from laterally facing edges of the laterally extending portion 84 of the spacing member 92 and also extends outwardly from a leading edge of the laterally extending portion 84. A lateral locating structure 98 extends upwardly from the horizontally extending portion 94 and is generally U-shaped to abut forward and lateral faces of the mullions. Additionally, the lateral locating structure 98 may include arcuate portions 100 that extend partially around first and second laterally extending portions 48, 52 of the mullions 28, 30. It also is contemplated that the locating structures 88 and 90 in the embodiment, described above, may include arcuate portions 100.

In the embodiments of the spacing member illustrated in FIGS. 5 and 7, the spacing member is non-handed and may be used for support of a mullion positioned on either side of a door, without being modified. Accordingly, separate position-specific spacing members are not necessary. As such, the number of different or unique components necessary to create different jamb arrangements is reduced. Additionally, the forward face of the spacing member is “squared-off”, or generally coplanar with the forward face of the mullion supported thereon (shown in FIG. 6). In this manner, componentry, such as for a storm door, may be placed and secured flush to the mullion, without interference from the spacing member.

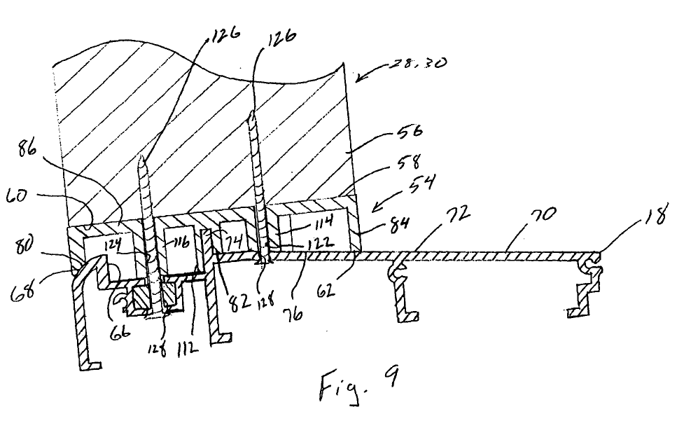

FIG. 8 illustrates one possible construction of the spacing member 54, as a generally hollow body. The hollow body defines a first pocket 102 and a second pocket 104. As shown, the sill engaging surface 62 may be provided by a peripheral edge portion of the hollow body. The peripheral edge portion defines an outer peripheral surface 106 and interior peripheral surfaces 108, 110. The first and second pockets 102, 104 may be divided by an interior wall member 112. As shown, the wall member 112 may provide a leading portion of the depending second portion 78 and a rearward portion of the first portion 76. Additionally, the channel 82 may be formed extending within the wall member 112 and extending longitudinally therethrough. The spacing members 54 and 84 may have a solid construction. The present invention, however, is not limited to the use of a hollow body; rather, the body may be formed as a solid body.

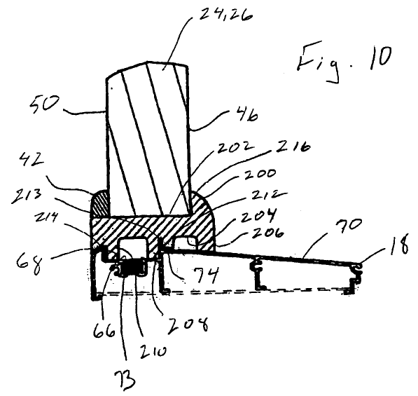

Additionally, the hollow body provides a pair of support studs 114, 116, which generally are positioned centrally within respective pockets 102, 104. Terminal ends of the support studs 114, 116 provide support surfaces 118, 120 that are coplanar with the sill engaging surface 62. The support studs 114, 116 also include generally vertically extending recesses 122, 124 formed therein. As shown in FIGS. 5 and 9, the recesses 122, 124 extend between the sill engaging surface 62 and the mullion supporting surface 58. As further shown in FIG. 9, fasteners 126 may be inserted within the recesses 122, 124 to extend therethrough and into the lower portions 56 of the mullion 28, 30. The fasteners 126 may be in the form of screws, bolts, nails, or other suitable fasteners. It is noted that the fasteners 126 may not be utilized at all, or that in lieu of such fasteners, other suitable fasteners may be used, such as adhesive. A suitable caulking material may be applied along the perimeter of one of the mullion and the spacing member to provide a waterproof connection therebetween. The sill structure 18 may be provided with a pair of vertically extending openings 128, which correspond to the locations of the recesses 122, 124 to allow the fasteners 126 to extend therethrough. It is also contemplated that the locating structures 88 and 90 may include recesses for receiving fasteners therein to secure the mullion to the spacing member 54.

It is contemplated that the spacing member may be formed of a synthetic material, such as by injection molding or casting a polymer material or a composite material (polymer-based, or otherwise). It is noted that a synthetic material may be preferable for constructing the spacing member, since this type of material is generally resistant to decay or other degradation. It is also contemplated that the spacing member may be formed of a composite material containing a mixture of wood fiber and polymer. It is also contemplated that the spacing member may be cast from a metallic material. Additionally, the spacing member may be machined from materials such as metals, polymers, composites, wood, etc. Furthermore, the spacing member may be formed from other rigid materials, such as concrete.

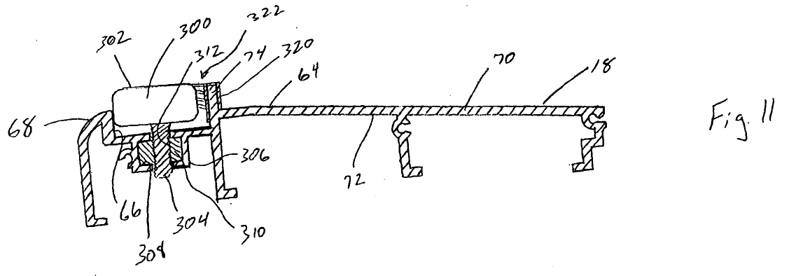

As shown in FIGS. 2 and 10, support of the side panels 24, 26 by the sill structure 18 may be facilitated by use of side panel spacers 200. Similarly as with the spacing member 54, the side panel spacer 200 includes a substantially flat panel support surface 202 and a sill engaging surface 204 that is generally shaped to compliment the topographic configuration of the sill structure 18. The panel spacer 200 includes a leading edge depending portion 206 that extends downwardly to engage the upwardly facing surface 64 of the sill structure 18. The panel spacer 200 also includes a spaced pair of intermediate depending portions 208, 210 that are arranged to abut side walls of the channel 66 and engage the bottom surface 73 thereof. A retaining portion 212 is spaced slightly forwardly of the depending portion 208 to provide an upwardly extending channel 213 within which the lip structure 74 may be disposed. A downwardly facing surface of the channel 213 engages the upwardly facing surface 85 of the lip structure 74. A trailing edge portion 214 of the panel spacer 200 includes an arcuate surface configured to engage the curved trailing edge portion 68. Furthermore, the panel spacer 200 includes an upwardly extending flange structure 216 arranged to abut the first face 46 of the side panels 24, 26. Caulking or other suitable sealant may be located between the first face 46 and the flange structure 216. The glazing bead 42 may be secured to the trailing edge portion 214 of the panel spacer 200 to thereby retain the panel 24, 26 between the flange structure 216 and glazing bead 42.

It is contemplated that the panel spacer 200 may be formed from a polymer material, such as by an extrusion process. It is also contemplated that the spacer 200 may be formed by extruding metallic or composite materials. Additionally, the spacer 200 may be formed, for example, by machining, casting, extruding, or molding any of polymer, metallic, or composite materials (including those including wood fiber and polymer). Other suitable materials and processes may also be utilized.

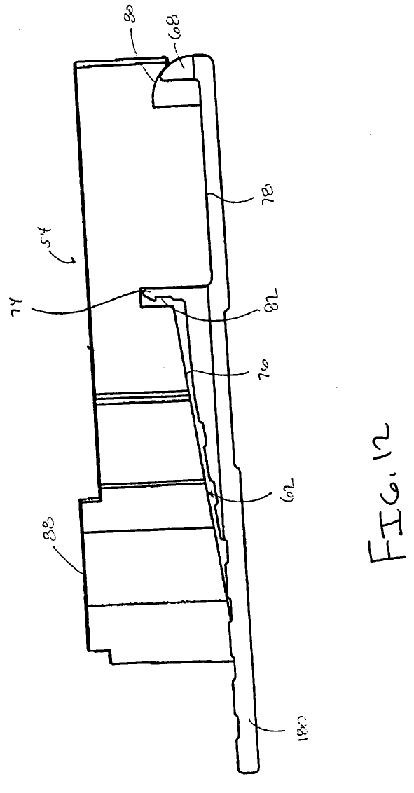

To effect a seal and allow spacing adjustment between the door 22 and the sill structure 18, a rail member 300 may be disposed within the channel 66 beneath the door 22, as shown in FIG. 11. The rail member 300 is mounted within the channel 66 such that a height of the rail member 300 relative to the sill structure 18 may be adjusted to adjust spacing difference between a downwardly facing surface of the door 22 and an upwardly facing surface 302 of the rail member 300. At least one fastener 304 is rotationally mounted to the rail member 300 to extend downwardly therefrom and in such a manner so as to allow manual rotation of the fasteners 304. It may be preferable for the fasteners 304 to extend through the rail member 300, to allow for manual adjustment thereof. A depending structure 306 of the sill structure 18 forms a pocket 308 therein which allows for formation of a polymer thermal break 310 therein. In particular, a polymer or other suitable material, may be injected or cast within the pocket 308 to form the polymer thermal break 310. As shown in FIG. 11, the thermal break 310 may have threaded apertures 312 provided therein for threaded engagement with respective fasteners 304. In this manner, the fasteners 304 may be rotated to correspondingly adjust a height thereof above the bottom surface 73 of the channel 66. To enhance thermal isolation, a sealing member 320 may be attached to the rib structure 74 to be in sealing engagement with the rail member 300. As shown in FIG. 10, the sealing members 320 may include a plurality of resilient flange structures 322 that extend from the sealing member 320 and resiliently engage an adjacent side of the rail member 300, thereby defining a corresponding plurality of pockets therebetween. The present invention, however, is not limited to the above-described adjustable rail member; rather, numerous other adjustment assemblies may be employed. The adjustment assembly may be integrated into the rail assembly as disclosed in U.S. Provisional Patent Application No. 60/414,655. The disclosure of which is incorporated herein specifically by reference. For example, the adjustment mechanism for the rail may be integrated into the sill assembly and extend the entire length of the sill, as disclosed in U.S. Provisional Patent Application No. 60/441,079. The disclosure of which is specifically incorporated herein by reference. Alternatively, the rail member may be vertically adjusted through the use of one or more adjustment shims, as disclosed for example in U.S. Provisional Patent Application No. 60/441,106. The disclosure of which is specifically incorporated herein by reference.

The spacing member 54 or 84 and the panel spacer 200, described above, are formed as separate components. This reduces the number of unique components and allows the same components to be used in jambs having a left side lights and/or right side lights. With this arrangement, however, it is possible for the assembler to misalign the components, which could lead to air and water leaks. The use of a sealing material between the spacing member and the panel spacer would prevent this. It is also possible to secure these components together using an adhesive, a suitable fastener or other possible means including a biscuit prior to assembly.

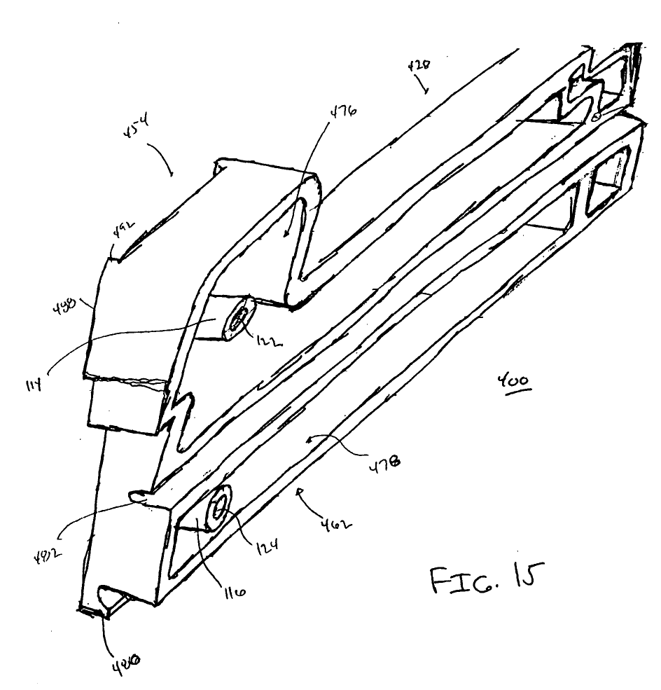

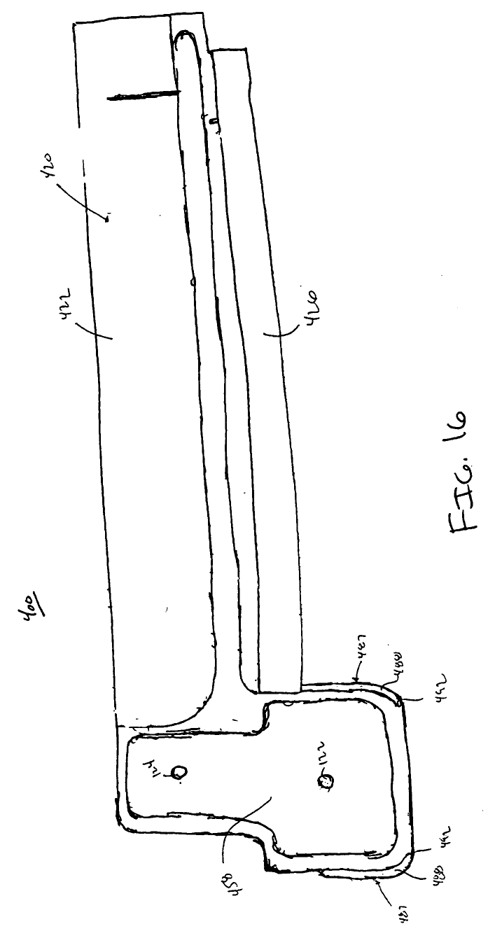

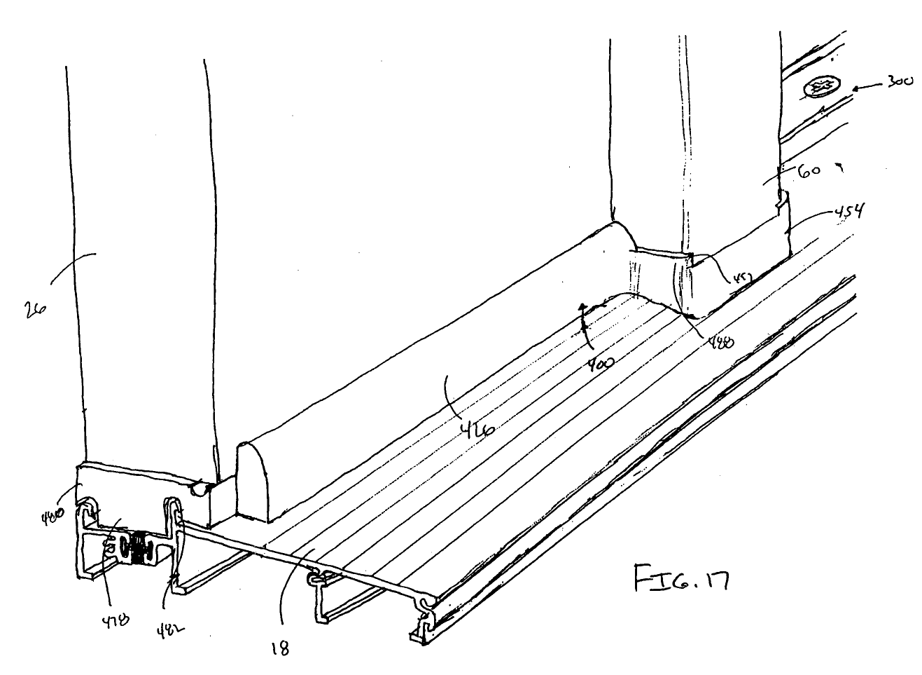

In accordance with another embodiment of the present invention, the spacing member and the panel spacer may be formed as a single unit. This reduces the number of steps for the assembler when producing the jamb. The combined spacing member and panel spacer component 400 is illustrated in FIGS. 14-17. Separate right side (FIGS. 14-16) and left side (FIG. 17) components must be provided for right and left side lites. The combined component 400 includes a spacing member 454 and a panel spacer 420 disposed on the sill structure 18. The component 400 may be used with either a high profile sill 18 or a low profile sill 180. Shown in greater detail in FIG. 14, the spacing member 454 of the component 400 includes a generally horizontally extending mullion supporting surface 458 that engages a downwardly facing surface of the mullion. Additionally, the spacing member 454 and the support spacer 420 include a sill engaging surface 462 that is contoured to a topographic configuration of the sill structure 18, as shown in FIG. 15 or sill structure 180. It is noted that the upwardly facing surface of the sill structure may be formed with any shape, construction, or configuration and that the sill engaging surface 462 of the spacing member 454 may be configured to compliment any of these.

To compliment the upwardly facing surface of the sill structure, the sill engaging surface 462 of the component 400 may be formed with a first portion 476 that is inclined to be generally parallel with the inclined portion of the sill structure 18. The first portion 476 extends the length of the spacing member 454 and support portion 420. The sill engaging surface 462 may also include a generally depending second portion 478 generally parallel with the mullion supporting surface 458 to be received within a channel in the sill to engage a bottom surface of the channel. The second portion 478 extends the length of the spacing member 454 and the panel spacer 420. A third portion 480 may be provided by the sill engaging surface 462 and may be inclined and generally arcuate to cooperate with the arcuate trailing edge portion of the sill. The third portion 480 also extends the length of the spacing member 454 and the panel spacer 420. Furthermore, the spacing member 454 may be formed with a laterally extending channel 482 to receive the lip structure 74 of the sill. The channel extends the length of the spacing member 454 and the panel spacer 420, as shown in FIG. 15. Like the surface 62 described above, the surface 462 is not limited to the above-described configuration; rather, numerous configurations are contemplated provided the surface 462 as a configuration that is complementary to the upper surface of the sill.

Like the spacing members 54 and 84, it is also noted that the component 400 is substantially prevented from lateral movement relative to the sill structure, due to an interlocking cooperation between the lower surface of the component 400 and the upper surfaces of the sill. As shown in FIGS. 14, 16 and 17, the mullion engaging surface 458 is shaped to generally coextend with downwardly facing surface of the mullions. Accordingly, the spacing member 454 includes a laterally extending portion 484, which extends outwardly corresponding to the laterally extending portions of the mullions and a longitudinally extending portion 486. Additionally, the spacing member 454 may be provided with a horizontally extending portion 487 that extends outwardly from at least one side of the spacing member 454 past a horizontal extent of the mullion. A lateral locating structure 488 may be provided extending upwardly from the horizontally extending portion 487 to abut a peripheral surface of the mullion, thereby providing lateral support thereof in at least one direction. The lateral locating structures 488 may engage corresponding lateral faces of the mullions and include arcuate portions 492 to, at least, partially engage a forward face of the mullions. The spacing member 454 having the lateral locating structures is self-draining through a space between the locating structures 488. Accordingly, water is substantially prevented from collecting between the spacing member 454 and the corresponding mullion. As illustrated in FIG. 15, the component 400 is formed as a generally hollow body. It is also contemplated that the component 400 may have a solid construction. The spacing member 454 may include grooves 89 to receive weather striping.

The side panel spacer 420 has a similar construction to the spacer 200. The side panel spacer 420 includes a substantially flat panel support surface 422. The support surface 422 is substantially parallel to the mullion engaging surface 458. As shown in FIG. 14, the support surface 422 is slightly raised above the surface 458. The panel spacer 420 includes an upwardly extending flange structure 426 arranged to abut the first face 46 of the side panels 24, 26.

It will be appreciated that numerous modifications to and departures from the preferred embodiments described above will occur to those having skill in the art. Thus, it is intended that the present invention covers the modifications and variations of the invention, provided they come within the scope of the appended claims and their equivalents.

What is claimed is:

1. A spacing member for a door jamb assembly including a horizontally extending sill structure disposed between and connected to ends of a pair of vertically extending jamb members, a horizontally extending header structure disposed between and connected to opposite ends of the jamb members, and at least one vertically extending mullion disposed between the jamb members, the spacing member comprising:
a body structure with a pair of opposing surfaces, one of the surfaces having a mullion-supporting surface to support the at least one mullion thereon, the other of the opposing surfaces having a contoured sill-engaging surface to generally conform to a topographic configuration of the sill, wherein the body structure is configured such that, when the sill-engaging surface is engaged with the sill, the mullion-supporting surface is oriented generally horizontally.

2. The spacing member as in claim 1, wherein the body structure has a generally complimentary shape to the mullion.

3. The spacing member as in claim 2, wherein at least a first portion of the sill-engaging surface is inclined with respect to the mullion-supporting surface.

4. The spacing member as in claim 3, wherein at least a second portion of the sill-engaging surface is generally parallel to the mullion-supporting surface.

5. The spacing member as in claim 4, wherein at least a third portion of the sill-engaging surface is inclined with respect to the mullion-supporting surface.

6. The spacing member as in claim 5, wherein the second portion is disposed between the first and third portions.

7. The spacing member as in claim 1, wherein the body structure includes a horizontally extending portion configured to extend horizontally outwardly past the mullion.

8. The spacing member as in claim 7, wherein at least one lateral locating structure extends vertically from the horizontally extending portion past the mullion-supporting surface.

9. The spacing member as in claim 1, wherein the body structure includes a laterally extending channel formed therethrough, a portion of the channel providing at least a portion of the sill-engaging surface.

10. The spacing member as in claim 1, wherein the body structure is formed from a synthetic material.

11. The spacing member as in claim 1, wherein the body structure is configured to be engageable with the sill structure such that lateral movement of the spacing member relative to the sill structure is substantially prevented.

12. The spacing member as in claim 11, wherein the body structure is configured to be engageable with the sill structure such that longitudinal movement of the spacing member relative to the sill structure is allowed.

13. A sill assembly for a doorjamb assembly including a pair of vertically extending jamb members having a horizontally extending header structure disposed therebetween and connected to an end of each jamb member and a vertically extending mullion disposed between the jamb members, the combination comprising:
a longitudinally extending sill structure connected at each end thereof to ends of the jamb members opposite the header structure,
a spacing member including a body structure with a pair of opposing surfaces, one of the surfaces having a mullion-supporting surface to support the mullion thereon, the other of the opposing surfaces having a contoured sill-engaging surface to generally conform to a topographic configuration of the sill, wherein the body structure is configured such that, when the sill-engaging surface is engaged with the sill, the mullion-supporting surface is oriented generally horizontally.

14. The sill assembly as in claim 13, wherein the sill structure includes a generally longitudinally, vertically facing channel, the body structure of the spacing member having a first portion thereof that extends outwardly therefrom and being receivable within the channel.

15. The sill assembly as in claim 14, wherein the first portion provides at least a portion of the sill-engaging surface thereon, which abuts a vertically facing surface of the channel.

16. The sill assembly as in claim 13, wherein the sill structure includes a generally longitudinally extending, vertically protruding lip structure, the body structure of the spacing member having a recess formed laterally therethrough, the lip structure being receivable within the recess.

17. The sill assembly as in claim 16, wherein the recess provides at least a portion of the sill-engaging surface therein, which abuts a vertically facing surface of the lip structure.

18. A continuous head and sill assembly comprising:
a pair of horizontally spaced, vertically extending jamb members;
a header structure connected to and extending between first ends of the jamb members;
at least one vertically extending mullion disposed between the jamb members and connected on one end thereof to the header structure;
a longitudinally extending sill structure connected at each end thereof to ends of the jamb members opposite the header structure, and
at least one spacing member including a body structure with a pair of opposing surfaces, one of the surfaces having a mullion-supporting surface to support one of the at least one mullion thereon, the other of the opposing surfaces having a contoured sill-engaging surface to generally conform to a topographic configuration of the sill, wherein the body structure is configured such that, when the sill-engaging surface is engaged with the sill, the mullion-supporting surface is oriented generally horizontally.

19. A sill assembly for a door jamb assembly including a pair of vertically extending jamb members having a horizontally extending header structure disposed therebetween and connected to an end of each jamb member and at least one vertically extending mullion disposed between the jamb members, the combination comprising:
a longitudinally extending sill structure connected at each end thereof to ends of the jamb members opposite the header structure,
wherein the horizontally extending header structure, the sill structure, the vertically extending mullion, and an adjacent jamb member form a panel opening therebetween within which a side panel is disposed adjacent the door,
a panel spacer positioned between a bottom edge of the side panel and the sill structure, the panel spacer having a sill engaging surface configured to conform to a topographic configuration of the sill and a horizontally extending panel supporting surface opposite the sill engaging surface, a bottom edge of the side panel abutting the panel supporting surface, which thereby vertically supports the side panel;
a spacing member including a body structure with a pair of opposing surfaces, one of the surfaces having a mullion-supporting surface to support the mullion thereon, the other of the opposing surfaces having a contoured sill-engaging surface to generally conform to a topographic configuration of the sill, wherein the body structure is configured such that, when the sill-engaging surface is engaged with the sill, the mullion-supporting surface is oriented generally horizontally.

20. The sill assembly according to claim 19, wherein the panel spacer and the spacing member are formed as a single component.

21. The assembly according to claim 19, further comprising at least one lateral locating structure located adjacent the mullion-supporting surface, wherein the at least one lateral locating structure is configured to contact the at least one mullion to prevent lateral movement thereof.

22. The assembly according to claim 21, further comprising an upwardly extending flange extending substantially along a length of the side panel support surface, wherein the upwardly extending flange is adapted to engage a side panel supported on the side panel support surface.

23. The assembly according to claim 22, wherein one of the at least one lateral locating structure extends from the upwardly extending flange.

24. The sill assembly according to claim 23, further comprising an upwardly extending flange extending substantially along a length of the side panel support surface, wherein the upwardly extending flange is adapted to engage a side panel supported on the side panel support surface.

25. The sill assembly according to claim 19, wherein the body structure includes a horizontally extending portion configured to extend horizontally outwardly past the mullion.

26. The sill assembly according to claim 25, wherein at least one lateral locating structure extends vertically from the horizontally extending portion past the mullion-supporting surface.

27. The sill assembly according to claim 19, further comprising an upwardly extending flange extending substantially along a length of the side panel support surface, wherein the upwardly extending flange is adapted to engage a side panel supported on the side panel support surface.

28. The sill assembly according to claim 19, wherein the body structure includes a laterally extending channel formed therethrough, a portion of the channel providing at least a portion of the sill-engaging surface.

29. The sill assembly according to claim 19, further comprising at least one lateral locating structure located adjacent the mullion-supporting surface, wherein the at least one lateral locating structure is configured to contact the at least one mullion to prevent lateral movement thereof.

30. The combined spacing member and side panel support according to claim 29, further comprising an upwardly extending flange extending substantially along a length of the side panel support surface, wherein the upwardly extending flange is adapted to engage a side panel supported on the side panel support surface.

31. The combined spacing member and side panel support according to claim 30, wherein one of the at least one lateral locating structure extends from the upwardly extending flange.
